(19) United States
(12) Patent Application Publication
(10) Pub. No.: US 2007/0294600 A1
(43) Pub. Date: Dec. 20, 2007

(54) Method of detecting heartbeats and device thereof

(75) Inventors: Xing-Jia Wang, Taipei (TW); Tom Chen, Taipei (TW); Win-Ham Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/429,245

(22) Filed: May 8, 2006

(51) Int. Cl. G06F 11/00

(52) U.S. Cl. 714/55

(57) ABSTRACT

A method of detecting heartbeats and the device thereof are applied to a cluster server. It includes a first controller, a second controller, and a detecting module. The detecting module does the counting according to a first predetermined period. If the detecting module receives a first reset signal of the first controller before the first predetermined period, it determines that the operation of the first controller is normal. If the detecting module has not receive the first reset signal of the first controller before the first predetermined period, then the operation of the first controller is determined to be abnormal. The detecting module sends out a control signal to start the second controller. The second controller communicates with the first controller to execute the corresponding failure transfer program and to interrupt the operation of the first controller.

### BACKGROUND OF THE INVENTION

1. Field of Invention

The invention relates to a method and device of detecting heartbeats, and in particular, to a method and device with fail controller transfer that are used in a cluster server to detect heartbeats.

2. Related Art

With advances in semiconductor manufacturing techniques and integrated circuit (IC) designs, computers have been widely used for personal, family, academic research, military, business, and industrial purposes. The rapid development of the Internet enables a huge amount of information flow in the network. The fields of electronic business and academic researches, in particular, rely much on data processing and transfer. Therefore, they require a system or high-level server with powerful processing ability and high reliability for stable support and operations. To achieve this requirement, the system often employs the concept of clusters.

The idea of a cluster system was first proposed and built by the Kennedy Space Center. It was hoped to increase the parallel computing ability by coupling multiple personal computers (PCs) together. With the advantage of a lower price for the PC's, the overall cost of the system can be significantly reduced. The so-called cluster system is a parallel system or distribution system (DS), that is to say, computers are coupled to execute many application programs at the same time. Through a physical connection via a network and hierarchical cluster software, these computers can perform error tolerance transfer and load balance, achieving some tasks that cannot possibly be done by a single computer. Such a cluster system is composed of multiple PCs with individual operating resources respectively and multiple servers with accessible shared resources, so that it has very powerful ability to access application program.

Currently, cluster systems have been widely used in the server structure within enterprises. The storage system is used as the core. The connections among the storage system, the server host, and the network structure can be divided into three types: the direct-attached storage (DAS), the network-attached storage (NAS), and the storage area network (SAN). In view of the trend in network storage, SAN has the advantages of good extensibility and longer transmission than DAS and NAS. Therefore, it has become the mainstream of the field. SAN is a high-speed network storage structure devoted to data transmissions, which provides storage pool for the distributed servers. Its network channels can be tunneled to the server host via the exchange device or flow controller of fiber channels, or to the existing Ethernet via the Internet protocol over SCSI (iSCSI) technique.

The software heartbeat mode with periodic network signal checks for the fail detection in the conventional cluster system is used, but this implementation is affected by the network and the system. On one hand, it challenges the data security. On the other hand, the response via the network is slower. If this is used in SAN, it is difficult to ensure the availability and security for a huge amount of real time data

### SUMMARY OF THE INVENTION

It is a main objective of the invention to provide a heartbeat detection method implemented with hardware to solve problems existed in the prior art.

Therefore, the disclosed heartbeat detection method used in a cluster server includes a first controller, a second controller, and a detecting module. The method includes the following steps. First, a detecting module is provided. The detecting module has a counting function. It is set to count in accord with a first predetermined period. Afterwards, a first reset signal is transferred to the detecting module by the first controller in accord with a second predetermined period. When the detecting module receives the first reset signal sent from the first controller before the first predetermined period, the first controller is determined to be normal. The detecting module responds to the first reset signal for restarting the counting.

If the detecting module has not received the first reset signal before the first predetermined period, the first controller is determined to be abnormal. The detecting module sends out a control signal to start the second controller. The second controller then communicates with the first controller in order to execute the corresponding failure transfer program and to interrupt the operation of the first controller.

Therefore, the disclosed heartbeat detection method is implemented with hardware to ensure the availability of data. When executing operations, the system is not disturbed so as to reduce the misjudgment. On the other hand, the reliability of the system can be increased. In summary, its advantage is a good stability because the operation of the abnormal controller is interrupted without being limited by the system. Besides, the first predetermined period of the detecting module can be readily modified by the user.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram of a heartbeat detection device according to the present invention; and

FIG. 2 is a flowchart showing the steps of a heartbeat detection method according to the present invention.

### DETAILED DESCRIPTION OF THE INVENTION

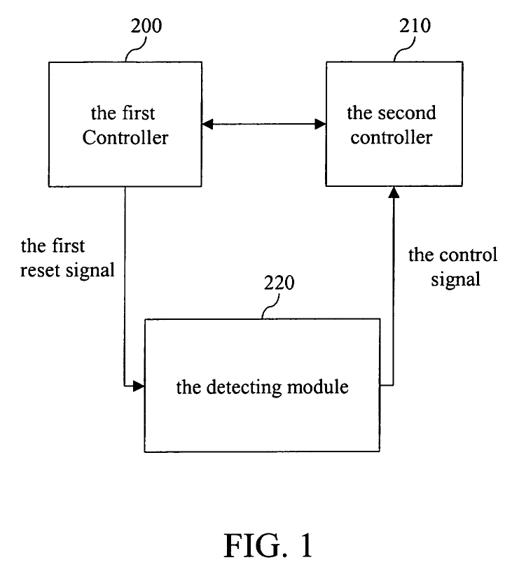

Referring to FIG. 1 of a heartbeat detection device according to the present invention. As shown in FIG. 1, the heartbeat detection device used in a cluster server includes a first controller 200, a second controller 210, and a detecting module 220.

The first controller 200 is used to control the operation of the cluster server, and sends out a first reset signal within a second predetermined period under normal conditions.

The second controller 210 is used to control the operation of the cluster server. Besides, when the second controller 210 receives the control signal sent from the detecting module 220 and starts, it sends out a second reset signal in accord with a third predetermined period. The second reset signal can be used to reset the counting function of the detecting module 220. The second controller 210 and the first controller 200 can communicate with each other in order to execute the corresponding failure transfer program. This enables the cluster server to continue with normal operations.

The detecting module 220 does counting in accord with a first predetermined period. (The first predetermined period should be greater than the second predetermined period of the first controller 200 and the third predetermined period of the second controller 210. The first predetermined period is editable, so that the user can modify it.)

In summary, if the detecting module 220 receives the first reset signal sent from the first controller 200 before the first predetermined period, then the first controller 200 is determined to be functioning normally. The detecting module 220 responds to the first reset signal and restarts the counting.

If the detecting module 220 has not received the first reset signal before the first predetermined period, the first controller 200 is determined to be functioning abnormally. The detecting module 220 then sends out a control signal to start the second controller 210. The second controller 210 communicates with the first controller 200 after it starts so as to execute the corresponding failure transfer program and to interrupt the operation of the first controller 200, thereby maintaining the operation of the cluster server. Due to the same mechanism, the second controller 210 continues monitoring and maintaining the operation of the cluster server. The detecting module 220 can use the second reset signal of the second controller 210 to reset its counting.

During the operation of the second controller 210, if the detecting module 220 receives again the first reset signal, then the detecting module 220 restarts its counting in accord with the first reset signal and simultaneously executes the corresponding failure transfer program. The first controller 200 and the second controller 210 communicate with each other in order to restore the operation of the first controller 200. A control signal is sent to interrupt the operation of the second controller 210.

A heartbeat detection method of the present invention uses a first reset signal sent out by a first controller 200 during a counting period of a detecting module 220 to determine whether the operation of the first controller 200 is normal.

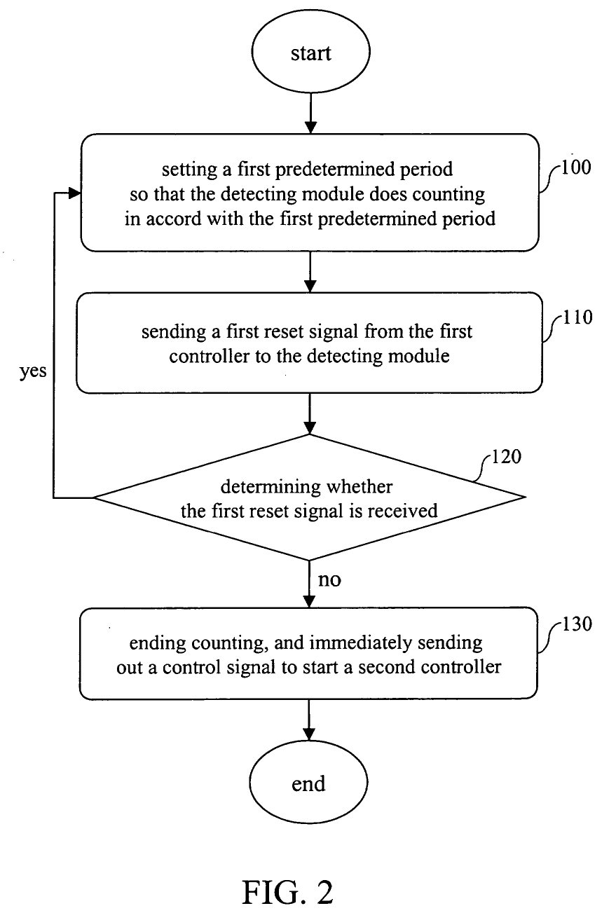

Referring to FIG. 2A of a flowchart showing the steps of a heartbeat detection method according to the present invention. As shown in FIGS. 1 and 2, the detection method includes the following steps.

First, a detecting module 220 is provided. The detecting module 220 has a counting function. The user can modify a first predetermined period of the detecting module 220. The detecting module 220 is set to count in accord with the first predetermined period (step 100).

Afterwards, a first reset signal is transferred to the detecting module 220 by the first controller 200 in accord with a second predetermined period (step 110).

When the detecting module 220 receives the first reset signal sent from the first controller before the first predetermined period, the first controller is determined to be normal. (The first predetermined period of the detecting module 220 should be greater than the second predetermined period of the first controller 200.) The detecting module 220 responds to the first reset signal to the first controller 200, and restarts the counting (step 120).

If the detecting module 220 has not received the first reset signal from the first controller 200 before the first predetermined period, the first controller 200 is determined to be abnormal. The detecting module 220 sends out a control signal to start the second controller 210 (step 130).

The second controller 210 then communicates with the first controller 200 in order to execute the corresponding failure transfer program. The second controller 210 further sends out an interrupt signal to interrupt the operation of the first controller 200.

Otherwise, if the detecting module 220 receives the first reset signal after starting the second controller 210, the detecting module 220 resets the count and executes the corresponding failure transfer program. Through the communication between the first controller 200 and the second controller 210, the operation of the first controller 200 is recovered, and then the operation of the second controller 210 is interrupted via a control signal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A heartbeat detection method, used in a cluster server with a first controller, a second controller, and a detecting module, comprising the steps of:
providing a detecting module and setting a first predetermined period so as to enable the detecting module to count in accord with the first predetermined period;
starting the first controller and sending a first reset signal to the detecting module in accord with a second predetermined period;
wherein when the detecting module receives the first reset signal before the first predetermined period, restarting the counting of the detecting module; and
wherein when the detecting module has not received the first reset signal before the first predetermined period, sending a control signal from the detecting module to start the second controller.

2. The heartbeat detection method of claim 1, further comprising the step of:
letting the second controller communicate with the first controller after its start so as to execute a corresponding failure transfer program.

3. The heartbeat detection method of claim 1, wherein the first predetermined period is variable.

4. The heartbeat detection method of claim 1, wherein the first predetermined period is greater than the second predetermined period.

5. The heartbeat detection method of claim 1, further comprising the step of:
when the detecting module receives again the first reset signal sent from the first controller, restarting the counting of the detecting module in accord with the first predetermined period, executing a corresponding failure transfer program in order to restore the operation of the first controller, and sending a control signal to interrupt the operation of the second controller.

6. A heartbeat detection device used in a cluster server, comprising:
a first controller, which sends out a first reset signal in accord with a second predetermined period;
a second controller, which controls the operation of the cluster server; and
a detecting module, which has a counting function, counts in accord with a first predetermined period, and sends a control signal to the second controller;
wherein the detecting module resets its counting in accord with the first reset signal.

7. The heartbeat detection device of claim 6, wherein the first predetermined period is variable.

8. The heartbeat detection device of claim 6, wherein the first predetermined period is greater than the second predetermined period.

9. The heartbeat detection device of claim 6, wherein the second controller communicates with the first controller after it receives the control signal and executes a corresponding failure transfer program.
